(19) United States
(12) Patent Application Publication
(10) Pub. No.: US 2026/0302804 A1
(43) Pub. Date: Oct. 1, 2026

(54) ENERGY STORAGE SYSTEM ARCHITECTURE

(71) Applicant: SCHNEIDER ELECTRIC IT CORPORATION, Foxboro, MA (US)

(72) Inventors: Aranganathan Narasimhan, Bangalore (IN); Harey Ram Pandey, Hyderabad (IN); Kapil Sunil Bhise, Bengaluru (IN); Pradeep Tolakanahalli Nagabhushanrao, Bangalore (IN); Chandrasekaran Jayaramen, Bangalore (IN)

(21) Appl. No.: 19/092,437

(22) Filed: Mar. 27, 2025

(51) Int. Cl. H02J 7/00; H01M 10/42; H01M 10/44; H01M 10/46; H02J 9/06

(52) U.S. Cl. CPC H02J 7/485; H01M 10/425; H01M 10/441; H01M 10/46; H02J 7/50; H02J 7/80; H02J 7/933; H01M 2010/4271; H02J 9/062; H02J 2207/20

(57) ABSTRACT

A power system supporting multiple battery chemistries is presented, including a battery bus; a first bidirectional coupler configured to be coupled to the battery bus and to a first battery having a first battery chemistry; a second bidirectional coupler configured to be coupled to a second battery having a second battery chemistry, the second battery chemistry being different than the first battery chemistry, and further being configured to be coupled to the battery bus; and at least one controller configured to: determine a first priority of the first battery and a second priority of the second battery, responsive to determining the first priority and the second priority, control one of the first bidirectional coupler or the second bidirectional coupler to selectively connect one of the first battery or the second battery to the battery bus based on which priority of the first priority and the second priority is higher.

### BACKGROUND

### 1. Field of the Disclosure

At least one example in accordance with the present disclosure relates generally to energy storage systems.

### 2. Discussion of Related Art

Power devices, such as uninterruptible power supplies (UPSs), may be used to provide regulated, uninterrupted power for sensitive and/or critical loads, such as computer systems and other data-processing systems. Existing UPSs include online UPSs, offline UPSs, line-interactive UPSs, as well as others. UPSs may provide output power to a load. The output power may be derived from a primary source of power, such as a utility-mains source, and/or derived from a back-up source of power, such as an energy-storage device.

### SUMMARY

According to at least one aspect of the present disclosure, a power system is presented, the power system configured to support multiple battery chemistries, and the power system comprising a battery bus; a first bidirectional coupler having a first output terminal and a first input terminal, the first output terminal configured to be coupled to the battery bus and the first input terminal configured to be coupled to a first battery having a first battery chemistry; a second bidirectional coupler having a second output terminal and a second input terminal, the second input terminal configured to be coupled to a second battery having a second battery chemistry, the second battery chemistry being different than the first battery chemistry, and the second output terminal being configured to be coupled to the battery bus; and at least one controller configured to: determine a first priority of the first battery and a second priority of the second battery, responsive to determining the first priority and the second priority, control one of the first bidirectional coupler or the second bidirectional coupler to selectively connect one of the first battery or the second battery to the battery bus based on which priority of the first priority and the second priority is higher.

In some examples, the at least one controller is further configured to: responsive to an in-use battery coupled to the battery bus falling to or below an undervoltage threshold, selectively decoupling the in-use battery from the battery bus and incrementing a plurality of counters corresponding to other batteries available to be coupled to the battery bus; and responsive to a first counter of the plurality of counters reaching a counter threshold, selectively coupling, via a respective bidirectional coupler, a battery corresponding to the first counter to the battery bus and resetting each other counter of the plurality of counters to an original value. In some examples the at least one controller is further configured to: determine whether a charging current exceeds a current threshold or falls below the current threshold; responsive to determining that the charging current exceeds the current threshold, selectively couple one or more batteries to the battery bus; and responsive to determining that the charging current falls below the current threshold, selectively couple one battery to the battery bus. In some examples, the power system further comprises a third bidirectional coupler, the third bidirectional coupler including a third output terminal, a third input terminal, a third plurality of switching devices, and a third inductor, wherein the third bidirectional coupler is coupled to the second bidirectional coupler and is configured to be coupled to a third battery having a third battery chemistry. In some examples, the first bidirectional coupler includes a first plurality of switching devices, and a first inductor, wherein the first plurality of switching devices includes a first switch, a second switch, a third switch, and a fourth switch, the first switch coupled between a first connection of the first inductor and a positive terminal of the first battery, the second switch coupled between the first connection and a negative terminal of the first battery, the third switch coupled between the negative terminal and a second connection of the first inductor, and the fourth switch coupled between the second connection and the first output terminal. In some examples, the at least one controller is further configured to determine which of the first priority and second priority is higher by: determining first battery parameters for the first battery; determining second battery parameters for the second battery; and based on the first battery parameters and the second battery parameters, determine the first priority and the second priority, wherein the first battery parameters include one or more of a state of health of the first battery, a remaining life cycle of the first battery, a state of charge of the first battery, or a capacity of the first battery, and wherein the second battery parameters include one or more of a state of health of the second battery, a remaining life cycle of the second battery, a state of charge of the second battery, or a capacity of the second battery. In some examples, the at least one controller determines which of the first priority or second priority is higher by determining that one battery of the first battery or the second battery has a higher state of health and assigning priority to that one battery. In some examples, the at least one controller further determines which of the first priority or second priority is higher by determining that each battery has a same state of health and, responsive to determining that each battery has a same state of health, determining that one battery of the first battery or the second battery has a longer remaining life cycle and assigning priority to that one battery. In some examples, the at least one controller further determines which of the first priority or second priority is higher by determining that each battery has the same remaining life cycle and, responsive to determining that each battery has the same remaining life cycle, determining that one battery of the first battery or the second battery has a higher state of charge and assigning priority to that one battery. In some examples, the at least one controller further determines which of the first priority or second priority is higher by determining that each battery has a same state of charge and, responsive to determining that each battery has a same state of charge, determining that one battery of the first battery or the second battery has a higher capacity and assigning priority to that one battery.

According to at least one aspect of the present disclosure, a method of controlling a power system is presented, comprising: selectively coupling a first battery of a plurality of batteries to a battery bus, the plurality of batteries including batteries having different battery chemistries, the first battery having a first priority and a first chemistry; monitoring a parameter of the first battery indicative of a remaining charge of the first battery; determining that the parameter meets a threshold condition indicative of the first battery being discharged below a discharge threshold; and responsive to the parameter meeting the threshold condition, decoupling the first battery from the battery bus and selectively coupling a second battery of the plurality of batteries to the battery bus, the second battery having a second priority less than the first priority and having a second chemistry different than the first chemistry.

In some examples, the method further comprises activating a first buck-boost converter to adjust a voltage of the battery bus to match a first voltage of the first battery responsive to selectively coupling the first battery to the battery bus. In some examples, the method further comprises responsive to the first voltage dropping to an undervoltage threshold, decoupling the first battery from the battery bus and controlling a second buck-boost converter to adjust the voltage of the battery bus to match a second voltage of the second battery as part of selectively coupling the second battery to the battery bus. In some examples, the method further comprises responsive to the first voltage dropping to an undervoltage threshold, decoupling the first battery from the battery bus and controlling the first buck-boost converter to adjust the voltage of the battery bus to match a second voltage of the second battery as part of selectively coupling the second battery to the battery bus. In some examples, responsive to a charging current from the battery bus being less than a first current threshold, disabling a first buck-boost converter coupled to the first battery and closing a first bypass switch of the first battery to selectively couple the first battery to the battery bus. In some examples, responsive to a charging current from the battery bus being greater than a first current threshold, activating a first buck-boost converter and selectively coupling, directly or indirectly, the first battery and the second battery to the battery bus.

According to at least one aspect of the present disclosure, a non-transitory computer-readable medium is presented, containing thereon instructions for operating a power system, the instructions instructing at least one processor to: control at least one first switch to selectively couple a first battery to a battery bus, the first battery having a first battery chemistry and a first priority; and control at least one second switch to selectively couple a second battery to the battery bus, the second battery having a second battery chemistry different from the first chemistry and a second priority.

In some examples, the first battery chemistry is a different battery chemistry than the second battery chemistry. In some examples, the instructions further instruct the at least one processor to: initialize one or more counters, the one or more counters including a first counter corresponding to the first battery and a second counter corresponding to the second battery, the first counter initialized to a first value, and the second counter initialized to a second value less than the first value; increment the first counter at a rate; increment the second counter at the rate; responsive to the first counter reaching a threshold value, control the at least one first switch to selectively couple the first battery to the battery bus; responsive to the first counter reaching the threshold value, reset the second counter; responsive to the first battery discharging to an undervoltage threshold, increment the second counter at the rate; and responsive to the second counter reaching the threshold value, control the at least one second switch to selectively coupled the second battery to the battery bus. In some examples, the instructions further instruct the at least one processor to: monitor a first voltage of the first battery; responsive to the first voltage reaching a first threshold voltage, control the at least one first switch to selectively decouple the first battery from the battery bus; responsive to decoupling the first battery from the battery bus, selectively couple the second battery to the battery bus; monitor a second voltage of the second battery; and responsive to the second voltage reaching a second threshold voltage, control the at least one second switch to selectively decouple the second battery from the battery bus. In some examples, the instructions further instruct the at least one processor to: responsive to a charging current provided at the battery bus being less than a first current threshold, disable a first buck-boost converter coupled to the first battery and close a first bypass switch of the first battery to selectively couple the first battery to the battery bus; and responsive to the charging current provided at the battery bus being greater than a second current threshold, activating a first buck-boost converter and selectively couple, directly or indirectly, the first battery and the second battery to the battery bus.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates a block diagram of a UPS according to an example;

FIG. 2 illustrates a block diagram of a power system according to an example;

FIG. 3 illustrates a diagram of a power system according to an example;

FIG. 4 illustrates a diagram of a power system according to an example;

FIG. 5 illustrates a diagram of a power system according to an example;

FIG. 6 illustrates a diagram of a power system according to an example;

FIG. 7A illustrates a graph of a discharging process according to an example;

FIG. 7B illustrates a graph of a charging process according to an example;

FIG. 8 illustrate a flowchart of a process for coupling batteries to a battery bus according to an example;

FIG. 9 illustrates a flowchart of a process for assigning priority to batteries according to an example;

FIG. 10 illustrates a flowchart of a process for charging one or more batteries;

FIG. 11 illustrates a flowchart of a process for incrementing one or more counters according to an example; and

FIG. 12 illustrates a graph of a process of incrementing one or more counters according to an example.

### DETAILED DESCRIPTION

In some power systems, such as uninterruptible power supplies (“UPSs”) (for example, online UPSs, offline UPSs, line-interactive UPSs, or other types), energy storage systems, battery coupler systems, and so forth, power can be provided from batteries to a load or loads being powered by the power system. However, most power systems are limited to using only a single battery chemistry at a time. This is because batteries of different chemistries may charge to different voltage levels, discharge at and/or to different voltage levels, and so forth. Additionally, batteries of different chemistries may have different lifespans and form factors, tolerate different levels of stress, and deteriorate at different rates. This makes it challenging to use batteries of different chemistries in a single power system.

Aspects of this disclosure relate to systems and methods for using batteries of multiple different chemistries in the same power system. For example, one aspect of this disclosure relates to a charging and/or discharging system that is equipped to handle the different chemistries at the same time. Another aspect includes an algorithm for handling the charging and discharging of the batteries that are connected to and in use by the power system.

In some examples presented herein, each battery is equipped with a module that includes a bidirectional converter. Each bidirectional converter may be configured to permit a given battery to discharge, charge, or be bypassed. Furthermore, in some examples, multiple batteries may be charging, discharging, or bypassed at the same time.

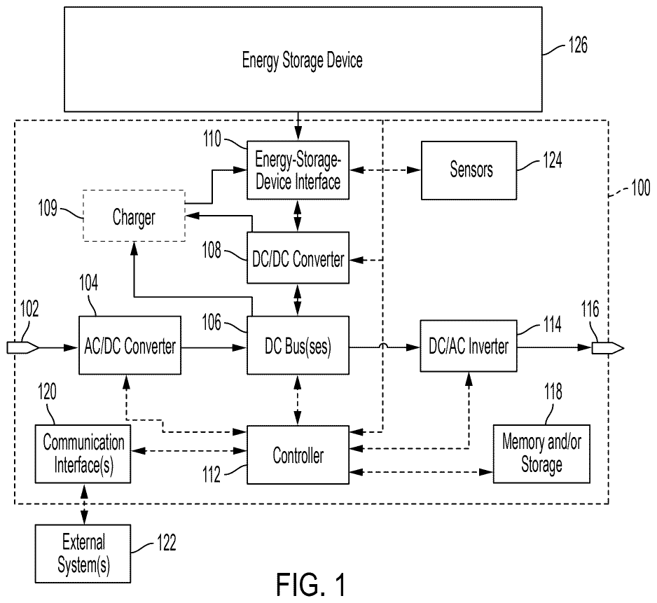

FIG. 1 is a block diagram of a UPS 100 according to an example. The UPS 100 includes an input 102, an AC/DC converter 104, one or more DC busses 106, a DC/DC converter 108, an optional charger 109, an energy-storage-device interface 110, at least one controller 112 (“controller 112”), a DC/AC inverter 114, an output 116, a memory and/or storage 118, one or more communication interfaces 120 (“communication interfaces 120”), which may be communicatively coupled to one or more external systems 122 (“external systems 122”), and one or more voltage sensors and/or current sensors 124 (“sensors 124”).

The input 102 is coupled to the AC/DC converter 104 and to an AC power source (not pictured), such as an AC mains power supply. The AC/DC converter 104 is coupled to the input 102 and to the one or more DC busses 106, and is communicatively coupled to the controller 112. The one or more DC busses 106 are coupled to the AC/DC converter 104, the DC/DC converter 108, and to the DC/AC inverter 114, and are communicatively coupled to the controller 112. The DC/DC converter 108 is coupled to the one or more DC busses 106 and to the energy-storage-device interface 110, and is communicatively coupled to the controller 112. The energy-storage-device interface 110 is coupled to the DC/DC converter 108, and is configured to be coupled to at least one energy-storage device 126 and/or another energy-storage device.

In some examples, the UPS 100 may be external to the at least one energy-storage device 126 and may be coupled to the at least one energy-storage device 126 via the energy-storage-device interface 110. In various examples, the UPS 100 may include one or more energy-storage devices, which may include the energy-storage device 126. The energy-storage device 126 may include one or more batteries, capacitors, flywheels, or other energy-storage devices in various examples.

The DC/AC inverter 114 is coupled to the one or more DC busses 106 and to the output 116, and is communicatively coupled to the controller 112. The output 116 is coupled to the DC/AC inverter 114, and to an external load (not pictured). The controller 112 is communicatively coupled to the AC/DC converter 104, the one or more DC busses 106, the DC/DC converter 108, the energy-storage-device interface 110, the DC/AC inverter 114, the memory and/or storage 118, and the communication interfaces 120. The sensors 124 are communicatively coupled to the controller 112 and may be coupled to one or more other components of the UPS 100, such as the input 102, the AC/DC converter 104, the one or more DC busses 106, the DC/DC converter 108, the energy-storage-device interface 110, the DC/AC inverter 114, and/or the output 116.

The input 102 is configured to be coupled to an AC mains power source and to receive input AC power having an input voltage level. The UPS 100 is configured to operate in different modes of operation based on the input voltage of the AC power provided to the input 102. The controller 112 may determine a mode of operation in which to operate the UPS 100 based on whether the input voltage of the AC power is acceptable. The controller 112 may include or be coupled to one or more sensors, such as the sensors 124, configured to sense parameters of the input voltage. For example, the sensors 124 may include one or more voltage and/or current sensors coupled to the input 102 and being configured to sense information indicative of a voltage at the input 102 and provide the sensed information to the controller 112.

When AC power provided to the input 102 is acceptable (for example, by having parameters, such as an input voltage value, that meet specified values, such as by falling within a range of acceptable input voltage values), the controller 112 controls components of the UPS 100 to operate in a normal mode of operation. In the normal mode of operation, AC power received at the input 102 is provided to the AC/DC converter 104. The AC/DC converter 104 converts the AC power into DC power and provides the DC power to the one or more DC busses 106. The one or more DC busses 106 distribute the DC power to the DC/DC converter 108 and to the DC/AC inverter 114. The DC/DC converter 108 converts the received DC power and provides the converted DC power to the energy-storage-device interface 110.

In some examples, the charger 109 may be coupled to the energy-storage-device interface 110 and configured to provide power to the energy-storage-device interface 110. In some examples, the charger 109 may be coupled to the DC bus 106 and/or DC/DC converter 108 and configured to transfer power with the DC bus 106 and/or DC/DC converter 108. The charger 109 may receive power from the DC/DC converter and/or DC bus 106, condition the power to have appropriate characteristics (such as voltage), and provide the conditioned power to the energy-storage-device interfaced 110.

The energy-storage-device interface 110 receives the converted DC power, and provides the converted DC power to the energy-storage device 126 to charge the energy-storage device 126. The DC/AC inverter 114 receives DC power from the one or more DC busses 106, converts the DC power into regulated AC power, and provides the regulated AC power to the output 116 to be delivered to a load.

When AC power provided to the input 102 from the AC mains power source is not acceptable (for example, by having parameters, such as an input voltage value, that do not meet specified values, such as by falling outside of a range of acceptable input voltage values), the controller 112 controls components of the UPS 100 to operate in a backup mode of operation. In the backup mode of operation, DC power is discharged from the energy-storage device 126 to the energy-storage-device interface 110, and the energy-storage-device interface 110 provides the discharged DC power to the DC/DC converter 108. The DC/DC converter 108 converts the received DC power and distributes the DC power amongst the one or more DC busses 106. For example, the DC/DC converter 108 may evenly distribute the power amongst the one or more DC busses 106. The one or more DC busses 106 provide the received power to the DC/AC inverter 114. The DC/AC inverter 114 receives the DC power from the one or more DC busses 106, converts the DC power into regulated AC power, and provides the regulated AC power to the output 116.

In some examples, the sensors 124 may include one or more sensors coupled to one or more of the foregoing components such that a voltage and/or current of one or more of the foregoing components may be determined by the controller 112. The controller 112 may store information in, and/or retrieve information from, the memory and/or storage 118. For example, the controller 112 may store information indicative of sensed parameters (for example, input-voltage values of the AC power received at the input 102) in the memory and/or storage 118. The controller 112 may further receive information from, or provide information to, the communication interfaces 120. The communication interfaces 120 may include one or more communication interfaces including, for example, user interfaces (such as display screens, touch-sensitive screens, keyboards, mice, track pads, dials, buttons, switches, sliders, light-emitting components such as light-emitting diodes, sound-emitting components such as speakers, buzzers, and so forth configured to output sound inside and/or outside of a frequency range audible to humans, and so forth), wired communication interfaces (such as wired ports), wireless communication interfaces (such as antennas), and so forth, configured to exchange information with one or more systems, such as the external systems 122, or other entities, such as human beings. The external systems 122 may include any device, component, module, and so forth, that is external to the UPS 100, such as a server, database, laptop computer, desktop computer, tablet computer, smartphone, central controller or data-aggregation system, other UPSs, and so forth.

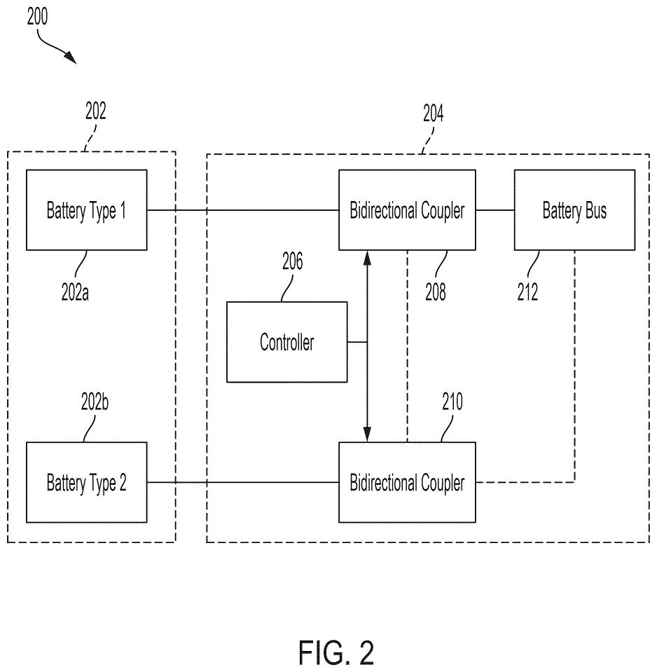

FIG. 2 illustrates a block diagram of a power system 200 according to an example. In some examples, the power system 200 may be a system configured to store energy (e.g., an energy storage system). The power system 200 can support multiple batteries and connect them, individually or simultaneously, to a battery bus. The power system 200 includes a plurality of batteries 202 including a first battery 202a of a first type, and a second battery 202b of a second type. The power system 200 further includes a power distribution system 204 including at least one controller 206 (“controller 206”), a first bidirectional coupler 208, a second bidirectional coupler 210, and a battery bus 212.

The first battery 202a is coupled to the first bidirectional coupler 208. The second battery 202b is coupled to the second bidirectional coupler 210. The controller 206 is communicatively coupled to the first bidirectional coupler 208 and the second bidirectional coupler 210. The first bidirectional coupler 208 is coupled to the battery bus 212.

The second bidirectional coupler 210 may be coupled to either the first bidirectional coupler 208 or to the battery bus 212. That is, the second bidirectional coupler 208 may be directly coupled to the first bidirectional coupler 208 and not coupled to the battery bus 212, or the second bidirectional coupler 208 may be directly coupled to the battery bus 212 and not coupled to the first bidirectional coupler 208. Both topologies are encompassed by this disclosure.

The first battery 202a is configured to provide power to the first bidirectional coupler 208. The first bidirectional coupler 208 is then configured to selectively connect the power from the first battery 202a to the battery bus 212, where the power from the first battery 202a may be used. Additionally, the first bidirectional coupler 208 is also configured to receive power from the battery bus 212 and selectively provide that power to the first battery 202a, for example to charge the first battery 202a. In circumstances where the first bidirectional coupler 208 and second bidirectional coupler 210 are coupled together, the first bidirectional coupler 208 may be further configured to selectively couple the second bidirectional coupler 210 to the battery bus 212, for example, by providing a conducting path between the second bidirectional coupler 210 and the battery bus 212.

The second battery 202b is configured to provide power to the second bidirectional coupler 210. The second bidirectional coupler 210 is then configured to selectively connect the power from the second battery 202b to the battery bus 212, in cases where the second bidirectional coupler 210 is coupled directly to the battery bus 212, or to selectively connect the power from the second battery 202b to the first bidirectional coupler 208. The first bidirectional coupler 208 may then provide a path from the second bidirectional coupler 210 to the battery bus 212. Similarly, the second bidirectional coupler 210 may also selectively couple the battery bus 212 to the second battery 202b either directly or through the first bidirectional coupler 208 to provide power to charge the second battery 202b.

The controller 206 is configured to control the bidirectional couplers 208, 210. For example, the controller 206 may control which connections of a bidirectional coupler 208, 210 are open or closed (that is, not connected or connected). For example, the controller 206 may control whether the first bidirectional coupler 208 is selectively coupling the first battery 202a to the battery bus 212 or not, or selectively coupling the second bidirectional coupler 210 to the battery bus 212 or not. Likewise, the controller 206 can control whether the second bidirectional coupler 210 is selectively coupling the second battery 202b to the battery bus 212 or to the first bidirectional coupler 208, or not, as appropriate depending on to which of the first bidirectional coupler 208 or battery bus 212 the second bidirectional coupler is coupled.

The controller 206 may also execute, monitor, and/or control an algorithm that is used to determine the states of the bidirectional couplers 208, 210 and therefore which of the batteries 202a, 202b are connected to the battery bus 212.

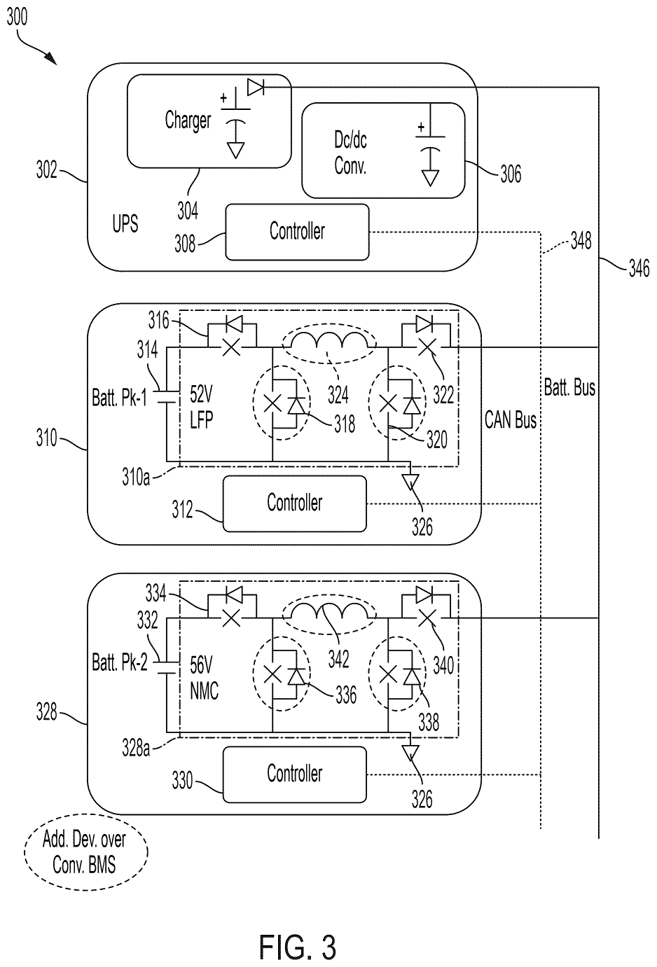

FIG. 3 illustrates a schematic diagram of a power system 300 according to an example. The power system 300 is an example of a “parallel” topology for using batteries of different chemistries in the same system. The power system 300 includes a UPS 302, a first battery module 310, a second battery module 328, a battery bus 346, and a Controller Area Network (CAN) bus 348.

The UPS 302 includes a charger circuit 304 (“charger 304”), a DC/DC converter circuit 306 (“DC/DC converter 306”), and a first controller 308. The first battery module 310 includes a second controller 312, a first battery 314, and a first bidirectional coupler 310a, the first bidirectional coupler 310a including a first switching device 316 (“first switch 316”), a second switching device 318 (“second switch 318”), a third switching device 320 (“third switch 320”), a fourth switching device 322 (“fourth switch 322”), a first inductance 324 (“first inductor 324”) and a reference node 326.

The second battery module 328 includes a third controller 330, a second battery 332, and a second bidirectional coupler 328a, the second bidirectional coupler 328a including a fifth switching device 334 (“fifth switch 334”), a sixth switching device 336 (“sixth switch 336”), a seventh switching device 338 (“seventh switch 338”), an eighth switching device 340 (“eighth switch 340”), a second inductance 342 (“second inductor 342”), and the reference node 326.

The charger 304 is coupled to the DC/DC converter 306 and to the battery bus 346. The DC/DC converter 306 is coupled to the charger 304 and to the battery bus 346. The first controller 308 is coupled to the CAN bus 348.

A first connection of the first battery 314 is coupled to a first connection of the first switch 316, and a second connection of the first battery 314 is coupled to a second connection of the second switch 318, a second connection of the third switch 320, and to the reference node 326. The first connection of the first switch 316 is coupled to the first connection of the first battery 314. The second connection of the first switch 316 is coupled to the first connection of the second switch 318 and to the first connection of the first inductor 324. The first connection of the second switch 318 is coupled to the second connection of the first switch 316 and to the first connection of the inductor 324. The second connection of the second switch 318 is coupled to the second connection of the first battery 314, the reference node 326, and the second connection of the third switch 320. A first connection of the third switch 320 is coupled to the second connection of the first inductor 324 and to the first connection of the fourth switch 322. A second connection of the third switch 320 is coupled to a second connection of the battery 314, a second connection of the second switch 318, and to the reference node 326. A second connection of the fourth switch 322 is coupled to the battery bus 346. The second controller 312 is coupled to the CAN bus 348.

A first connection of the second battery 332 is coupled to a first connection of the fifth switch 334. A second connection of the second battery 332 is coupled to the second connections of the sixth and seventh switches 336, 338 and to the reference node 326. A second connection of the fifth switch 334 is coupled to the first connection of the sixth switch 336 and to the first connection of the second inductor 342. A first connection of the seventh switch 338 is coupled to a second connection of the second inductor 342 and to a first connection of the eighth switch 340. A second connection of the eighth switch 230 is coupled to the battery bus. Second connections of both the sixth switch 336 and seventh switch 338 are coupled to each other and to the second connection of the second battery 332 and to the reference node 326. The third controller is coupled to the CAN bus 348.

The controllers 308, 312, 330 may communicate with one another. In some examples, the controllers 308, 312, 330 may share instructions, status information, and so forth. In some examples, the first controller 308 may request power, and the second and third controllers 312, 330 may determine which of the first and second batteries 314, 332 should provide the power. The second controller 312 may control the switches 316-322 of the first battery module 310, and the third controller 330 may control the switches 334-340 of the second battery module 328.

The switches 316-322 and inductor 324 of the first battery module 310 may function together as a first bidirectional coupler. The switches 334-340 and second inductor 342 of the second battery module 328 may function as a second bidirectional coupler.

The batteries 314, 332 may be of different battery chemistries. For example, the first battery 314 may be a first battery type, such as lithium-ion, and the second battery may be a second battery type, such as lithium nickel manganese cobalt oxides (NMC). In other examples, other battery types may be implemented.

In the power system 300, the battery modules 310, 328 are arranged in parallel with respect to each other and the UPS 302. Each battery module 310, 328 can therefore selectively connect its respective battery 314, 332 to the battery bus 346 independently of the other battery module 310. By sharing communication between controllers 308, 312, 330 via the CAN bus 348, the controllers 308, 312, 330 can determine which battery 314, 332 should be connected at a given time. Therefore, the controllers 308, 312, 330 can selectively couple one battery of the batteries 314, 332 at a first time, and the other battery of the batteries 314, 332 at a second time.

For example, suppose it is preferable to discharge and/or charge the first battery 314 before the second battery 332. As discussed in greater detail below, the controllers 308, 312, 330 may determine that it is advantageous to discharge and/or charge the first battery 314 before the second battery 332, and then connect the first battery 314 to the battery bus 346. The first battery 314 may then discharge (or charge, as the case may be) until a given threshold is reached. In some examples, the threshold may be a charge threshold, a voltage threshold, or any other electrical threshold corresponding to an electrical characteristic of the batteries 314, 332. In other examples, the threshold may be a value derivable based on one or more of the electrical characteristics of the batteries 314, 332. Once the threshold is reached, the controllers 308, 312, 330 may disconnect the first battery 314 and connect the second battery 332 so that the second battery may then discharge (or charge, as the case may be).

The controllers 312, 330 of the battery modules 310, 328 may also control the respective switches 316-322, 334-340 of their corresponding battery module 310, 328 to operate in different modes. Each battery module 310, 328 may, for example, be operated in a standby mode, a buck mode, a bypass mode, and/or a boost mode.

The second controller 312 may operate the first battery module 310 in standby mode by setting all the switches 316-322 to be off.

The second controller 312 may operate the first battery module 310 in the buck mode by controlling the first and second switches 316, 318 to turn on and off according to a duty cycle, and by controlling the third switch 320 to be off, and controlling the fourth switch 322 to be on.

The second controller 312 may control the first battery module 310 to be in bypass mode (which may also be called an on-mode) by controlling the first and fourth switches 316, 322 to be on, and the second and third switches 318, 320 to be off.

The second controller 312 may control the first battery module 310 to be in the boost mode by controlling the first switch 316 to be on, the second switch 318 to be off, and the third and fourth switches 320, 322 to turn on and off according to a duty cycle.

The third controller 330 may operate the second battery module 328 in standby mode by setting all the switches 334-340 to be off.

The third controller 330 may operate the second battery module 328 in the buck mode by controlling the fifth and sixth switches 334, 336 to turn on and off according to a duty cycle, controlling the seventh switch 338 to be off, and controlling the eighth switch 340 to be on.

The third controller 330 may control the second battery module 328 to be in bypass mode (or on-mode) by controlling the fifth and eighth switches 334, 340 to be on and the sixth and seventh switches 336, 338 to be off.

The third controller 330 may operate the second battery module 328 in the boost mode by controlling the fifth switch 334 to be on, the sixth switch 336 to be off, and the seventh and eighth switches 338, 340 to turn on and off according to a duty cycle.

In some examples, the buck mode of operation is used to reduce a voltage (for example, a voltage being provided by the battery bus 346 to a battery 314, 332, or a voltage being provided by a battery 314, 332 to the battery bus 346). That is, the buck mode permits a downward adjustment of a voltage. In contrast, in some examples, the boost mode of operation is used to increase the voltage. That is, the boost mode permits an upward adjustment of a voltage.

In some examples, the standby mode is used to disconnect a battery 314, 332 from the battery bus 346 so that the battery 314, 332 is not in use. In some examples, the bypass mode is used to provide power directly from a battery 314, 332 to the battery bus 346.

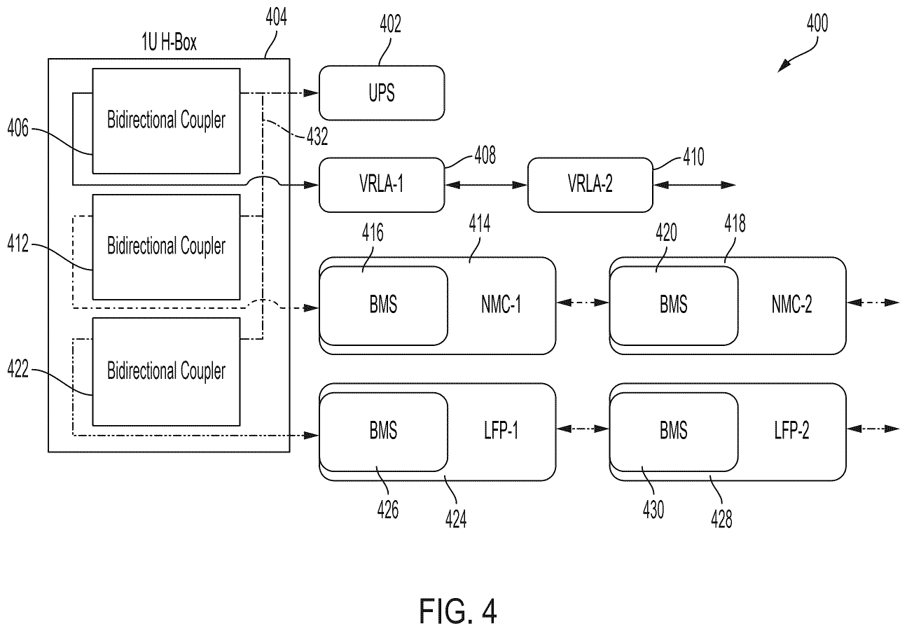

FIG. 4 illustrates a block diagram of a parallel topology of a power system 400 according to an example. For purposes of example, the power system 400 provides an example in which a valve regulated lead-acid (VRLA) battery, an NMC battery, and a lithium iron phosphate (LFP) battery are implemented. In other examples, other types of batteries may be implemented.

The power system 400 includes a UPS 402, a plurality of bidirectional couplers 404 including a first bidirectional coupler 406, a second bidirectional coupler 412, and a third bidirectional coupler 422, and a battery bus 432. The power system 400 further includes a first battery of a first type 408 (“VRLA 408”), a second battery of a first type 410 (“VRLA 410”), a first battery of a second type 414 (“NMC 414”), a second battery of a second type 418 (“NMC 418”), a first battery of a third type 424 (“LFP 424”), and a second battery of a third type (“LFP 428”). The NMC 414 includes a first battery management system (“BMS”) 416, the NMC 418 includes a second BMS 420, the LFP 424 includes a third BMS 426, and the LFP 428 includes a fourth BMS 430.

The UPS 402 is coupled to the battery bus 432, and the battery bus 432 is coupled to a first connection of the first bidirectional coupler 406, a first connection of the second bidirectional coupler 412, and a first connection of the third bidirectional coupler 422. A second connection of the first bidirectional coupler 406 is coupled to a first connection of the VRLA 408.

In some examples, each type of battery is coupled in the daisy-chain configuration with other batteries of the same type with respect to said batteries' corresponding bidirectional coupler. For example, the VRLAs 408, 410 are coupled in a daisy-chain with respect to the first bidirectional coupler 406, the NMCs 414, 418 are coupled in a daisy-chain with respect to the second bidirectional coupler 412, and the LFPs 424, 428 are coupled in a daisy-chain with respect to the third bidirectional coupler 422. For example, the first connection of the VRLA 408 (which may be the positive connection of VRLA 408) is coupled to the first connection of the VRLA 410 (which may be the positive connection of the VRLA 410). The second connection of the VRLA 408 (which may be the negative connection of the VRLA 408) may be coupled to ground, a reference node, or other node, and may also be coupled to the second connection of the VRLA 410 (which may be the negative connection of the VRLA 410). Likewise, in some examples, the first connection of the NMC 414 may be coupled to the first connection of the NMC 418 (both connections being positive connections), and the second connection of the NMC 414 may be coupled to ground, a reference node, or other node, and to the second connection of the NMC 418 (both connections being negative connections). Likewise, in some examples, the first connection of the LFP 424 may be coupled to the first connection of the LFP 428 (both connections being positive connections), and the second connection of the LFP 424 may be coupled to ground, a reference node, or another node, and may be coupled to the second connection of the LFP 428 (both connections being negative connections).

While only two batteries of each type 408, 410, 414, 418, 424, 428 are shown, any number of batteries of the same type may be coupled in a daisy-chain with one another as described above. Furthermore, in the topology of FIG. 4, only batteries of the same type are coupled in a daisy-chain with one another.

The VRLAs 408, 410 may be lead-acid-based batteries. The NMCs 414, 418 may be nickel-manganese-cobalt-based batteries. The LFPs 424, 428 may be lithium-ion-based batteries. In other examples, the VRLAs 408, 410, NMCs 414, 418, and LFPs 424, 428 may also be any other type or chemistry of battery provided that all VRLAs 408, 410 are of the same type, all NMCs 414, 418 are of the same type, and all LFPs 424, 428 are of the same type.

Each of the bidirectional couplers 406, 412, 422 may be identical to the bidirectional couplers 310a, 328a of FIG. 3, and/or may function in the same way. Thus, each bidirectional coupler 406, 412, 422 can operate in a buck mode, a boost mode, a standby mode, and a bypass mode. Each bidirectional coupler 406, 412, 422 may further include a respective controller, be in communication with an external controller, and/or be in communication with the UPS. Any of said controllers may control the bidirectional couplers 406, 412, 422.

The power system 400 permits the UPS 402 to receive power from any of the batteries 408, 410, 414, 418, 424, 428 and/or to send power to the batteries 408, 410, 414, 418, 424, 428. During operation, in general, one bidirectional coupler 406, 412, 422 may selectively couple a daisy-chain of batteries 408, 410, 414, 418, 424, 428 to the battery bus 432, while the other two of the bidirectional couplers 406, 412, 422 are not connecting a daisy-chain of batteries 408, 410, 414, 418, 424, 428 to the battery bus 432. As a given daisy-chain of batteries 408, 410, 414, 418, 424, 428 discharges and/or charges past a threshold level, a different set of batteries 408, 410, 414, 418, 424, 428 may be selectively connected to the battery bus 432 (and the previously connected daisy-chain disconnected).

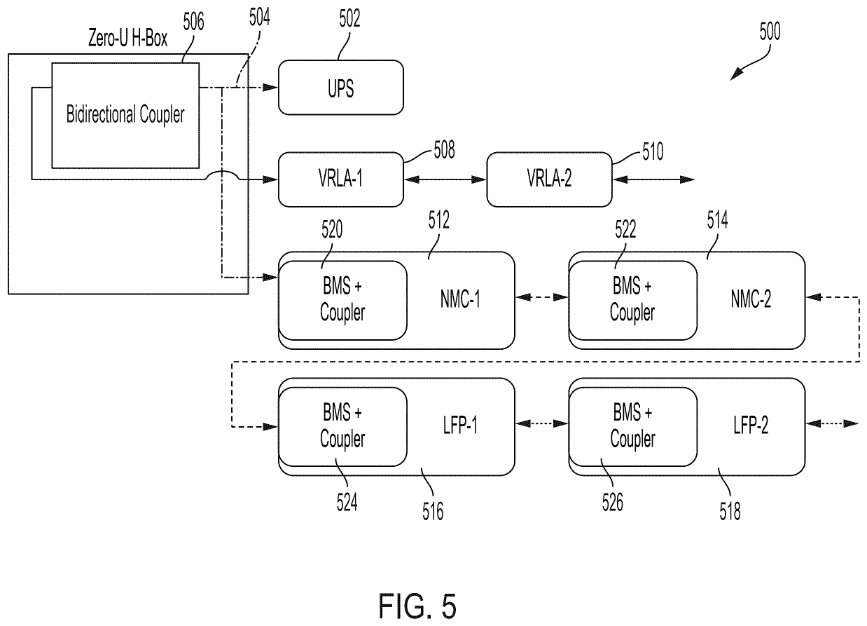

FIG. 5 illustrates a block diagram of a power system 500 according to an example. The power system 500 is configured to use multiple batteries of different chemistries at once, and additionally permits batteries of different chemistries to be connected to one another in a daisy-chain configuration.

The power system 500 includes a UPS 502, a battery bus 504, a bidirectional coupler 506, a first battery 508, a second battery 510, a third battery 512, a fourth battery 514, a fifth battery 516, and a sixth battery 518. The third battery 512 includes a first BMS-coupler 520, the fourth battery 514 includes a second BMS-coupler 522, the fifth battery 516 includes a third BMS-coupler 524, and the sixth battery 518 includes a fourth BMS-coupler 526. Each BMS-coupler 520-526 includes a bidirectional coupler, switch, or similar device, that may provide similar functionality as the bidirectional coupler 506.

The UPS 502 is connected to the battery bus 502. The battery bus 504 is coupled to a first connection of the bidirectional coupler 506 and to a first connection of the third battery 512. In some examples, the battery bus 504 is coupled to the first connection of the third battery 512 via the BMS-coupler 520. The bidirectional coupler 506 is coupled at a second connection to a first connection of the first battery 508. The first connection of the first battery 508 is connected to a first connection of the second battery 510.

In some examples, the third through sixth batteries 512-518 may be coupled in a daisy-chain configuration. That is, the first connection of the third battery 512 may be coupled to a first connection of the fourth battery 514, the first connection of the fourth battery 514 may be coupled to a first connection of the fifth battery 516, and the first connection of the fifth battery 516 may be coupled to a first connection of the sixth battery 518. In some examples, the first connections may be positive connections. Likewise, a second connection of the third battery 512 may be coupled to a second connection of the fourth battery 514, the second connection of the fourth battery 514 may be coupled to a second connection of the fifth battery 516, and the second connection of the fifth battery 516 may be coupled to a second connection of the sixth battery 518.

In some examples, the third through sixth batteries 512-518 are coupled together via the respective BMS-couplers 520-526 of the batteries 512-518. That is, in some examples, the first connection of the third battery 512 is a first connection of the first BMS-coupler 520 and the second connection of the third battery 512 is a second connection of the first BMS coupler 520. In some examples, the first connection of the fourth battery 514 is a first connection of the second BMS-coupler 522 and the second connection of the fourth battery 514 is a second connection of the first BMS coupler 522. In some examples, the first connection of the fifth battery 516 is a first connection of the third BMS-coupler 524 and the second connection of the fifth battery 516 is a second connection of the third BMS coupler 524. In some examples, the first connection of the sixth battery 518 is a first connection of the fourth BMS-coupler 526 and the second connection of the sixth battery 518 is a second connection of the fourth BMS coupler 526.

In some examples, each BMS-coupler 520-526 is equipped with a bidirectional coupler 506 that is identical in form and/or function to the bidirectional coupler 506. The bidirectional coupler 506 may, in turn, be identical in form and/or function to the bidirectional couplers 310a, 328a of FIG. 3. The batteries 508-518 may be of different types. For example, the first and second batteries 508, 510 may be of a first type, the third and fourth batteries 512, 514 may be of a second type, and the fifth and sixth batteries 516, 518 may be of a third type.

As explained above, the third through sixth batteries 512-518 may be coupled in a daisy-chain configuration with one another with respect to the battery bus 504. Accordingly, each battery 512-518 may be coupled in parallel with each other battery 512-518 with respect to the battery bus 504. This daisy-chain of the third through sixth batteries 512-518 may include any number of additional batteries provided the additional batteries are also coupled in parallel with the third through sixth batteries 512-518 with respect to the battery bus 504.

Because each of the third through sixth batteries 512-518 each include BMS-couplers 520-526 that have bidirectional couplers, it is possible to selectively remove any one or more of the third through sixth batteries 512-518 from the daisy-chain configuration of the third through sixth batteries 512-518 by decoupling the battery 512-518 from the battery bus 504 without disconnecting the other batteries 512-518 from the battery bus 504. For example, consider a situation in which the third battery 512 is fully discharged, but the other batteries 514-518 are not. In such a situation, the first BMS-coupler 520 can switch into an off mode wherein the third battery 512 is decoupled from the battery bus 504 while the fourth through sixth batteries 514-518 remain coupled to the battery bus 504.

One feature of the power system 500 compared to the power systems 300, 400 of FIGS. 3 and 4 is that any subgroup of one or more batteries 512-518 with a BMS-coupler 520-526 can individually be connected to the battery bus 504 by bypassing the other batteries 512-518 of the daisy-chain of batteries 512-518 by using the bidirectional switches associated with said batteries 512-518.

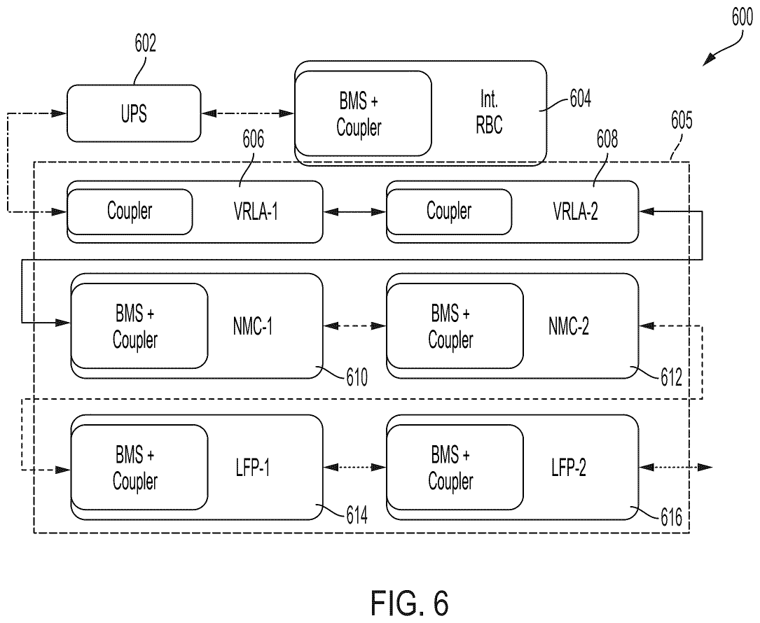

FIG. 6 illustrates a block diagram of a power system 600 according to an example. The power system 600 includes an internal replacement battery cartridge (“RBC”) 604, and a daisy-chain of batteries 605 that includes a first battery 606, a second battery 608, a third battery 610, a fourth battery 612, a fifth battery 614, and a sixth battery 616.

Each of the internal RBC 604 and batteries 606-616 include a corresponding BMS, and each of those BMSs includes a bidirectional coupler identical or functionally identical to those of FIG. 3.

A first connection of the UPS 602 is coupled to the internal RBC 604. A second connection of the UPS 602 is coupled to a first connection of the first battery 606.

In the daisy-chain of batteries 605, the first connection of the first battery 606 is coupled to a first connection of the second battery 608. The first connection of the second battery 608 is coupled to a first connection of the third battery 610. The first connection of the third battery 610 is coupled to a first connection of the fourth battery 612. The first connection of the fourth battery 612 is coupled to a first connection of the fifth battery 614. The first connection of the fifth battery 614 is coupled to a first connection of the sixth battery 616. As a daisy-chain, each battery 606-616 may be coupled in parallel with one another with respect to the UPS 602. For example, each battery 606-616 may be coupled in parallel with one another with respect to the first connection of the UPS 602.

The daisy-chain of batteries 605 may include one or more subgroups of one or more batteries. Each subgroup may have a chemistry that is different from the other subgroups.

The daisy-chain of batteries 605 works similarly to the batteries 512-518 of the power system 500 of FIG. 5. Each battery 606-616 may operate in buck, boost, on, standby, and/or bypass modes. As a result, any subgroup of one or more of the batteries 606-616 may be connected to the UPS 602 while the other batteries 606-616 of the daisy-chain of batteries 605 are not connected to the UPS 602.

In some examples, in contrast to some implementations of the topologies of FIGS. 3, 4 and 5, the topology of FIG. 6 may support an internal RBC 604. In some examples, the power system 600 may support the internal RBC 602 at least in part because the daisy-chain of batteries 605 are the only batteries coupled to the UPS 602 aside from the internal RBC 604.

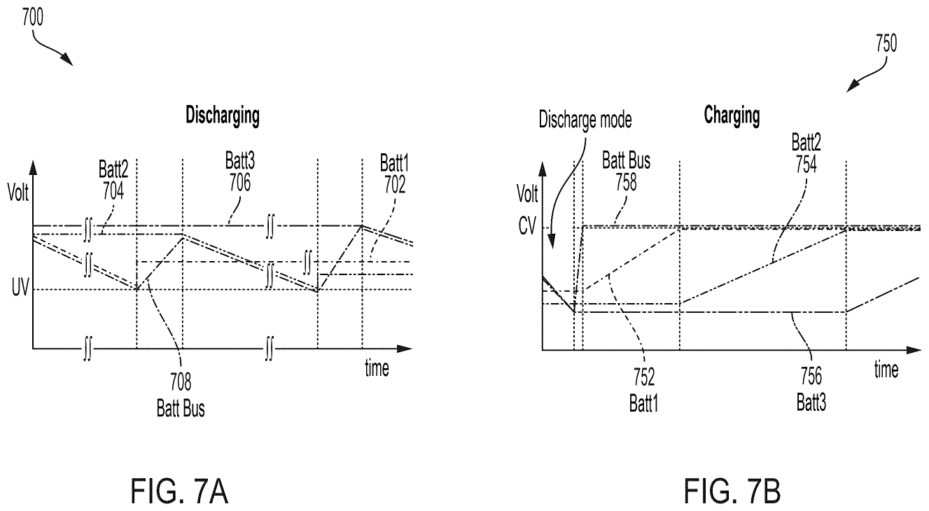

FIG. 7A illustrates a graph 700 of a discharging process according to an example. The graph 700 includes a first trace 702, a second trace 704, a third trace 706, and a fourth trace 708. The graph 700 has two axes, a time axis (the horizontal or x-axis) and a voltage axis (the vertical or y-axis).

The first trace 702 corresponds to a voltage of a first battery, the second trace 704 corresponds to the voltage of a second battery, the third trace 706 corresponds to the voltage of a third battery, and the fourth trace 708 corresponds to the voltage of a battery bus.

As illustrated, the first battery is coupled to the battery bus during an earliest time on the graph 700. The first trace 702 indicates that, as power is drawn from the first battery, the voltage level of the first battery falls, until the voltage of the first battery reaches a threshold voltage level, at which point the voltage is boosted and the second battery connects to the battery bus.

At that point, the fourth trace 708 begins to increase for the first time until the second battery has fully ramped up and taken over providing power to the battery bus. Then the second battery begins to discharge, corresponding to the second trace 704 decreasing in tandem with the fourth trace 708. Then, when the voltage of the second battery reaches a threshold voltage level, the third battery is connected and begins to ramp up to take over providing power. This is indicated by the fourth trace 708 beginning to increase of the second time, until the fourth trace 708 reaches the same level as the third trace 706, indicating that the voltage of the battery bus has reached the voltage of the third battery. Then the third trace 706 and fourth trace 708 begin to decrease in tandem, indicating that the third battery is now providing power to the battery bus.

Thus, the first graph 700 illustrates a general discharging process, whereby the battery bus is raised to the voltage level of an available battery, then the battery discharges to a threshold voltage level, at which point a next battery is activated and (optionally) the voltage of the previous battery is boosted. The voltage of the battery bus is increased to the level of the second battery, and then decreases as the second battery discharges to the threshold voltage level, at which point a third battery is connected and the process repeats itself.

FIG. 7B illustrates a graph 750 of a charging process according to an example. The graph 750 has a time axis (the horizontal or x-axis) and a voltage axis (the vertical or y-axis). The graph 750 includes a first trace 752, a second trace 754, a third trace 756, and a fourth trace 758. The first trace 752 corresponds to a voltage of a first battery. The second trace 754 corresponds to a voltage of a second battery. The third trace 756 corresponds to the voltage of a third battery. The fourth trace 758 corresponds to the voltage of a battery bus.

At a first time the voltage of the battery bus is increased, as indicated by the increasing portion of the fourth trace 758. Then, each of the three batteries corresponding to the other traces 752, 754, 756 is coupled to the battery bus to charge. The first battery is coupled to the battery bus first, and begins to charge, as indicated by the increasing section of the first trace 752. Once the first battery has reached a threshold voltage level, the first battery may be disconnected from the battery bus and/or the second battery may be connected to the battery bus. When the second battery is connected to the battery bus, the second battery begins to charge, as indicated by the increasing portion of the second trace 754.

When the second battery reaches a threshold voltage level, the second battery may be decoupled from the battery bus and/or the third battery may be coupled to the battery bus. When the third battery is coupled to the battery bus, the third battery begins to charge, as indicated by the increasing portion of the third trace 756. When the third battery reaches the threshold voltage level the third battery may be disconnected from the battery bus and/or a fourth battery connected to the battery bus, and so forth. In other examples, the charging process may continue indefinitely.

In some examples (not illustrated in FIGS. 7A and 7B) two batteries may be charged simultaneously, in which case the voltages of both batteries would increase simultaneously, though the battery bus voltage may be boosted or bucked by a bidirectional switch to facilitate the simultaneous charging.

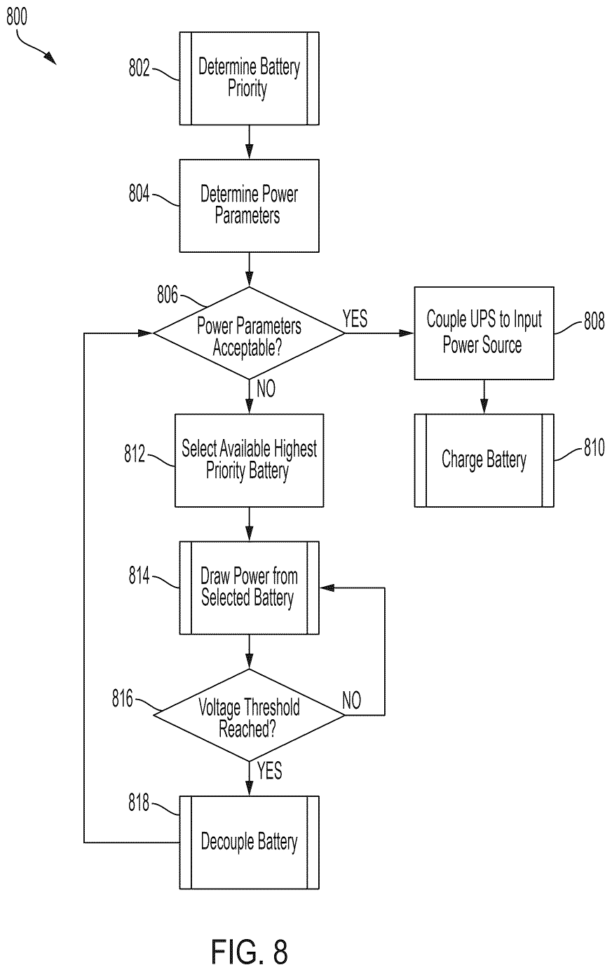

FIG. 8 illustrates a process 800 for controlling the charging and/or discharging of batteries in a power system including a plurality of batteries of different types according to an example. For example, the process 800 may provide an example of controlling any of the power systems 200-600 according to an example. For purposes of clarity and to illustrate one example, the process 800 is described as being executed by the controller 112.

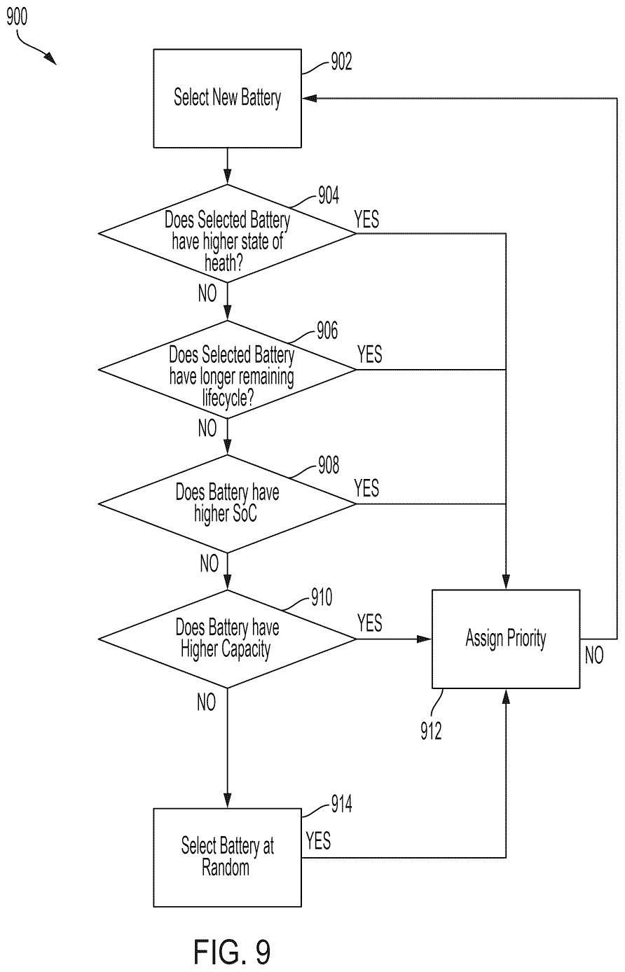

At act 802, the controller 112 determines the priority level of each battery associated with the power system. The priority level may be used to determine the order in which the batteries are charged and/or discharged. An example of act 802 is provided below with respect to FIG. 9. In some examples, the controller 112 may analyze health characteristics of the batteries, such health characteristics including, but not limited to, the state of health of the batteries, the remaining lifecycle of the batteries, the state of charge of the batteries, the capacity of the batteries, and so forth. The controller 112 may assign each battery a priority level based on the health characteristics of the battery. Once each battery is assigned a priority level, the process 800 may continue to act 804.

At act 804, the controller 112 determines one or more input power parameters. The input power parameters may be used to determine whether to use power from an external power source (such as a main power line) or using backup power (such as power from a battery). For example, the controller 112 may receive power-parameter information indicative of the input power from the sensors 124, which may include one or more current and/or voltage sensors. The process 800 may then continue to act 806.

At act 806, the controller 112 determines, based on the one or more input power parameters, whether the input power is acceptable. Act 806 may include the controller 112 comparing the one or more input power parameters to one or more pre-determined ranges or thresholds of acceptable power values. If the controller 112 determines that the power is acceptable (806 YES), then the process 800 may continue to act 808. If the controller 112 determines that the power is not acceptable (806 NO), then the process 800 may continue to act 812.

At act 808, the controller 112 controls the UPS 100 to provide power from the external power source to the load. The process 800 may then continue to act 810.

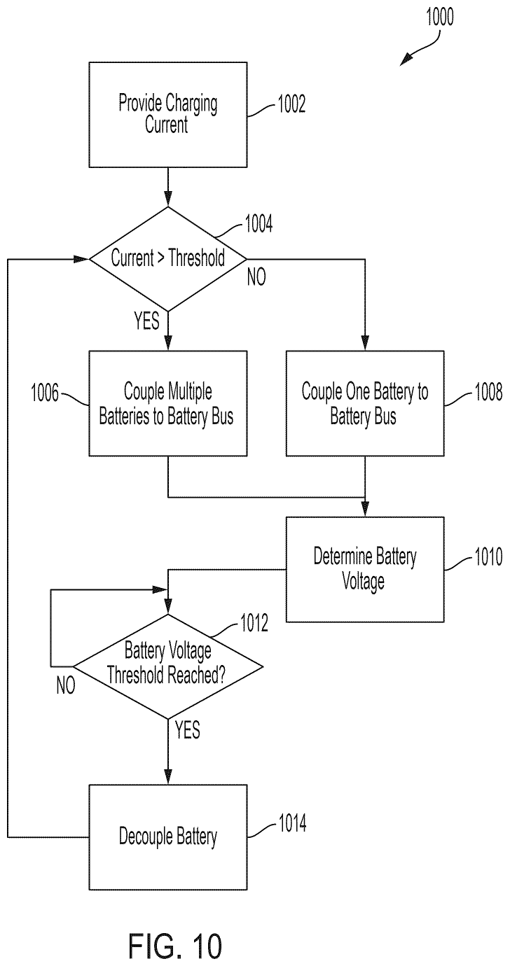

At act 810, the controller 112 may control the UPS to charge the batteries, for example, by providing a charging voltage and/or current to the batteries. Process 1000 of FIG. 10 illustrates one example of a process for charging the batteries.

Returning to act 806, if the controller 112 finds that power is not acceptable (806 NO), the process will continue to act 812.

At act 812, the controller 112 will select the available battery with the highest priority level to draw power from, for example, to provide backup power from the highest priority battery to the load. Note that, as discussed below with respect to act 818, act 812 may occur more than once as batteries are discharged and new batteries connected to provide power to the load. As a result, some batteries that may be available at one time may become unavailable, for example, due to being discharged, at a later time or different time. Therefore, act 812 may include the controller 112 selecting not the battery with the highest priority, but rather the battery with the highest priority that is also still available. An available battery may be a battery with sufficient charge remaining to provide power to the load for a period of time, and the controller 112 may determine that a battery is available based on such criterion or other criteria as the user desires. The period of time may be predetermined period of time (for example, five minutes, an hour, or any other amount of time), and the charge level may be known based on the capacity of the battery, the battery's state of charge, and the requirements of the load. Once the controller 112 has selected the highest priority battery that remains available, the process 800 may continue to act 814.

At act 814, the controller 112 may control the UPS 100 to provide power from the selected battery to the load. The process 800 may then continue to act 816.

At act 816, the controller 112 may determine if a voltage threshold has been reached, the voltage threshold being a predetermined voltage level less than the charged voltage of the battery (that is, the voltage of the battery when the battery is fully charged). The controller 112 may determine the voltage level of the battery by receiving indications of the voltage level of the battery from the sensors 124. If the controller 112 determines the voltage level of the battery is at or below the voltage threshold (816 YES), the process 800 may continue to act 818. If the controller 112 determines that the voltage level of the battery is not at or below the voltage threshold (816 NO), the process 800 may return to act 814.

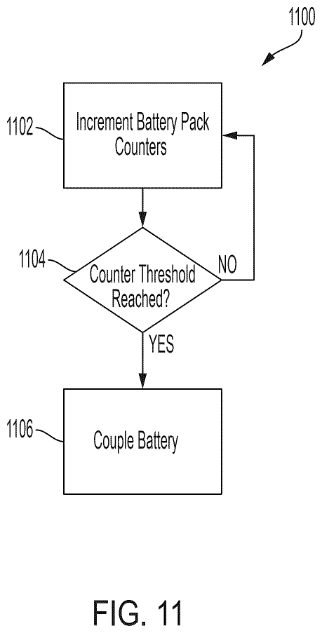

At act 818, the controller 112 may decouple the battery from the load in preparation to select a next battery to provide power to the load. The process 1100 of FIG. 11 is an example of how the controller 112 may decouple the battery as well as how the controller 112 may determine the next battery to couple to the load. The process 800 may then continue to act 806 to reevaluate the available power sources and to determine whether to return to drawing power from the external power source or switch to a different battery or other power source.

In some examples, acts 816 and 818 may be executed at least in part by a control device other than the controller 112. In some examples, an individual coupler controller configured to independently control the bidirectional coupler associated with the battery may instead control the coupling and decoupling. Non-exclusive examples of individual controllers configured to control the state of a bidirectional coupler may be any of the BMSs mentioned herein, the controller 206 of FIG. 2, and/or one or more of the controllers 308, 312, 330 of FIG. 3.

As discussed above, FIG. 9 may provide one example of act 802. FIG. 9 illustrates a process 900 for assigning priority to batteries according to an example.

At act 902 a controller, such as the controller 112, selects a battery to assign a priority level (“priority”) to. In some examples, the controller 112 may assign priority to a battery that has not previously received a priority assignment, or may assign priority to a battery whose priority has not been reevaluated within a threshold amount of time. In some examples, priority may be evaluated or reevaluated based on a condition occurring that affects the characteristics upon which the priority is based. For example, if the UPS 100 loses main power and switches to the batteries for backup power, when main power is reestablished the controller 112 may reevaluate priority. Once the controller 112 has selected a battery to assign a priority to, the process 800 may continue to act 904.

At act 904, the controller 112 may evaluate the state of health of the selected battery and compare the state of health of the selected battery to a state of health of one or more other batteries (for example, batteries that have previously been evaluated and assigned a priority). The state of health of the selected battery is an overall indication of the health of the selected battery, and may be determined based on one or more of the impedance, capacity, internal resistance, response under different frequencies, and so forth. In some examples, the state of health of the battery may be defined as the proportion of the maximum charge available of the battery compared to the rated capacity of the battery. That is, as batteries degrade over time, the maximum level of charge they can reach decreases from 100% of the rated capacity to a fraction of the rated capacity (for example, 99%, 50%, 25%, 1%, and so forth).

Once the controller 112 determines the state of health of the battery, the controller 112 determines whether the battery has a higher state of health than the state of health of at least one of the one or more other batteries. If the controller 112 determines that the battery has a higher state of health than the other battery or batteries (904 YES) (that is, higher than all other batteries for which a state of health has been determined), the process 900 may continue to act 912. If the controller 112 determines that the battery does not have a higher state of health than the state of health of the one or more other batteries (904 NO), the process 900 may continue to act 906.

At act 912, the controller 112 assigns a priority to the selected battery. The controller 112 may assign the priority based on the state of health, remaining lifecycle, state of charge, capacity, or randomly. In some examples, if the selected battery has a higher state of health than other batteries, the priority of the selected battery will be higher than the other batteries. That is, more generally, the controller 112 may assign priority such that the battery with the highest state of health is given the highest priority, the battery with the second highest state of health has the second highest priority, and so forth. For batteries having the same state of health, the controller 112 may differentiate them by assigning the battery with the longer lifecycle to have the higher priority.

For example, battery “A” may have a higher state of health than batteries “B” and “C,” and thus battery “A” may receive the highest priority. Batteries “B” and “C” may have the same state of health, but battery “C” may have the longer remaining lifecycle, and thus battery “C” may be assigned the second highest priority, and battery “B” assigned the third highest priority. For batteries having the same remaining lifecycle, the battery with the higher state of charge may be prioritized over the battery (or batteries) having lower states of charge. For batteries having the same state of charge, the battery having the higher capacity may be prioritized over the battery (or batteries) having lower capacity. When there is no characteristic that can be used to distinguish a priority level between two batteries (e.g., both batteries have the same state of health, same remaining lifecycle, same state of charge, and same capacity), then the higher relative priority may be assigned randomly to one of them. Thus, in some examples wherein the controller 112 is assigning priority, state of health may be given the most weight, followed by remaining life cycle, followed by state of charge, followed by capacity. In other examples, additional, fewer, or different parameters may be implemented, and/or may be implemented in the same or a different order of priority. Once the controller 112 assigns priority, the process 900 may continue to act 902.

Returning now to act 904, when the selected battery does not have the higher state of health (904 NO), the process 900 continues to act 906.

At act 906, the controller 112 determines whether the selected battery has a longer remaining lifecycle than at least one other battery (the at least one other battery not having a higher state of health compared to the selected battery). Battery lifecycle may be a value based on the chemistry, make, and/or model of the battery, and/or based on an algorithm that can predict the remaining lifespan of the battery based on characteristics (such as chemistry, voltage, impedance, make, model, and so forth) of the battery. If the controller 112 determines that the selected battery does have a longer remaining lifecycle relative to at least one other battery (906 YES), the process 900 may continue to act 912. As discussed above, the selected battery may be assigned a higher priority than available batteries having a lower remaining lifecycle but the same state of health. If the controller 112 determines that the selected battery does not have a longer remaining lifecycle relative to at least one other battery (906 NO), the process 900 may continue to act 908.

At act 908, the controller 112 determines whether the selected battery has a higher state of charge than at least one other battery (the at least one other battery not having a higher state of health or longer remaining lifecycle compared to the selected battery). Determining state of charge may include the controller 112 comparing the maximum available capacity of the selected battery to the current level of charge of the battery. If the controller 112 determines that the selected battery has a higher state of charge relative to at least one other battery (908 YES), the process 900 may continue to act 912. As discussed above, the selected battery may be assigned a higher priority than available batteries having a lower state of charge but the same state of health and remaining lifecycle. If the controller 112 determines that the selected battery has a lower state of charge relative to the at least one other battery (908 NO), the process 900 may continue to act 910.

At act 910, the controller 112 determines whether the selected battery has a higher capacity than at least one other battery (the at least one other battery not having a higher state of health, longer remaining lifecycle, or higher state of charge compared to the selected battery). In some examples, the capacity used here may be the remaining available capacity (rather than the maximum capacity from when the battery is new), as battery capacity tends to degrade over time and/or during periods of use. The controller 112 may determine the capacity of the selected battery using one or more sensors, such as the sensor 124, that is configured to sense the capacity or the characteristics of the battery used to derive the capacity. If the controller 112 determines that the selected battery has a higher capacity than the at least one other battery (910 YES), the process 900 may continue to act 912. As discussed above, the selected battery may be assigned a higher priority than available batteries having a lower capacity but the same state of health, remaining lifecycle, and state of charge. If the controller 112 determines that the selected battery does not have a higher capacity than the at least one other battery (910 NO), then the process 900 may continue to act 914.

At act 914, the controller 112 will have determined based on acts 904-910 that the selected battery has the same state of health, same remaining lifecycle, same state of charge, and same capacity as at least one other battery. The controller 112 may therefore select from between these at least two batteries one of the batteries to assign priority to (the priority for the other batteries then being assigned later as the process 900 repeats for every battery that has not received a priority). The randomly selected battery will then be assigned a priority during act 912. Once the controller 112 randomly selects a battery, the process 900 continues to act 912. In some examples, instead of randomly selecting from among the equivalent batteries, the controller 112 may simply select the battery that was being evaluated during this particular iteration of the process 900. That is, when the selected battery is equivalent to one or more other batteries, the selected battery may simply be chosen to be assigned a priority during act 912.

FIG. 10 illustrates a process 1000 for charging batteries according to an example. As discussed above, the process 1000 may be an example of act 810.

At act 1002, a controller, such as the controller 112, controls a circuit or device, for example the UPS 100, to provide a charging current to the battery bus, for example, the battery bus 346. This charging current may be used to charge batteries (for example, batteries coupled to the battery bus 346, 432, 504). The process 1000 may then continue to act 1004.

At act 1004, the controller 112 determines whether the charging current exceeds a current threshold. The current threshold may be determined by the controller 112 based on the characteristics of one or more batteries that can be coupled to the battery bus. The characteristics of the batteries may be characteristics such as charging voltages, internal resistances, impedances, capacity, and so forth. The controller 112 may consider these characteristics in determining the current threshold to assist in determining the number of batteries to charge during a given time. If the controller 112 determines that the charging current is greater than the current threshold (1004 YES), the process 1000 may continue to act 1006. If the controller 112 determines that the charging current is not greater than the current threshold (1004 NO), the process 1000 may continue to act 1008.

At act 1006, the controller 112 may control multiple batteries (e.g., via respective bidirectional switches of those batteries) to selectively couple to the battery bus. In some examples, the actual operation of coupling and decoupling is carried out by a different controller, such as a BMS of the battery, controller 206 of FIG. 2, or one or more of controllers 308, 312, 330 of FIG. 3. The controller 112 may control the bidirectional switches to operate in various modes—for example, one battery may be coupled to the battery bus with the bidirectional switch in buck mode, another battery may be coupled to the battery bus with the bidirectional switch in boost mode, another battery may be coupled with the bidirectional switch in the on-mode, and so forth. The total number of batteries that the controller 112 couples to the battery bus may be based on a total amount of energy the charging current can provide over a given period of time (e.g., total power the charging current can deliver), such that each battery can receive a charging voltage at least equal to the rated charging voltage corresponding to that battery. The process 1000 may then continue to act 1010. In certain examples of act 1006, a controller associated directly with a bidirectional coupler, such as the controller 206 of FIG. 2, controllers 308, 312, 330 of FIG. 3, and/or any of the BMSs discussed herein, may control the mode of operation of the bidirectional coupler and/or switches. For example, the controller 206 may receive instructions from the controller 112, but the controller 206 may be the controller that ultimately controls a bidirectional coupler or switch to change mode (e.g., buck to boost), and may be responsible for handling individual limitations of the battery with which the controller 206 is associated (e.g., may manage individual charge limitations and so forth).

At act 1008, the controller 112 may control a single battery to couple to the battery bus (e.g., via a bidirectional switch of that single battery). This single battery may then be charged using the charging current. The process 1000 may then continue to act 1010. As with act 1006, the controller 206 of the battery may be responsible for executing the coupling operations, and the controller 112 may instead merely provide instructions or commands. In still other examples, other individual controllers may be responsible for executing the coupling operations (for example, any of the BMSs discussed above).

At act 1010, the controller 112 may determine and/or monitor the voltages of the batteries that are coupled to the battery bus. For example, the controller 112 may use the sensors 124 to monitor the voltages of the batteries. The battery voltage of the batteries is not necessarily the same as the charging voltage. When a battery is discharged, the voltage of the battery tends to droop. When charging the battery, the charging voltage is generally higher than the discharged voltage of the battery. In some examples, when the voltage of the battery equals the charging voltage of the battery it means that the battery is fully charged. Thus, the voltage being measured by the controller 112 during act 1010 corresponds to the electro-motive force (“EMF”) of the battery. Once the controller 112 determines the voltages of the batteries, the process 1000 may continue to act 1012.

At act 1012, the controller 112 determines, for one or more of the batteries, if the voltage of the battery has reached a threshold voltage. The controller 112 may consider a unique threshold voltage for each battery and/or battery chemistry for batteries currently connected to the battery bus. The controller 112 is evaluating the voltages of the batteries to determine whether given batteries have reached a state of full charge, and as the fully-charged voltage of a battery of one chemistry (or one state of health) may differ from the fully-charged voltage of another battery, the controller 112 may therefore consider each battery that is coupled to the battery bus independently and with respect to a corresponding independent threshold voltage. If the controller 112 determines that a given battery (or batteries) has a voltage (corresponding to the EMF of the battery) that meets or exceeds the corresponding threshold voltage (1012 YES), the process 1000 may continue to act 1014 with respect to those batteries having a voltage that exceeds the threshold voltage. If the controller 112 determines that a given battery (or batteries) have voltages that do not meet or exceed the corresponding threshold voltage (1012 NO), the process 1000 may repeat act 1012 for the batteries with the voltages that do not meet or exceed the corresponding threshold voltage to monitor for a time when said voltages exceed the corresponding threshold voltages.

To further illustrate act 1012, suppose three batteries are coupled to the battery bus, these batteries being referred to as batteries “A,” “B,” and “C,” respectively. The controller 112 may determine, at a first time, that battery “A” has a voltage that meets or exceeds the threshold voltage that corresponds to battery “A” and may therefore proceed to act 1014 with respect to battery “A.” At the same time, the controller 112 may determine that batteries “B” and “C” have voltages that do not meet or exceed the corresponding respective threshold voltages for batteries “B” and “C” and may therefore continue to monitor the voltages of batteries “B” and “C.” When the voltage of battery “B” meets or exceeds the threshold voltage corresponding to battery “B,” then process 1000 may continue to act 1014 with respect to battery “B.” Likewise, when the voltage of battery “C” meets or exceeds the threshold voltage corresponding to battery “C,” then process 1000 may continue to act 1014 with respect to battery “C.”

At act 1014, the controller 112 may decouple the battery or batteries from the battery bus. The controller 112 decouples the batteries during act 1014 because the batteries, at this point, should be fully charged (or within a threshold percentage of fully charged, for example, +/−5%), and thus there is no reason to continue charging these batteries using the charging current. Instead, different batteries that have yet to be charged may instead be charged. Therefore, the process 1000 may continue to act 1004 so that the controller 112 may evaluate the charging current compared to the current threshold, and then couple (as in acts 1006, 1008) additional batteries to the battery bus as warranted.

FIG. 11 illustrates a process 1100 for determining when to couple a battery to the battery bus during a discharging process. As discussed above, FIG. 11 may illustrate an example of act 818. In some examples, the process 1100 may be used when, for example, priority levels were not assigned to the batteries or priority levels are not known.

At act 1102 a controller of an individual battery or bidirectional coupler, such as the controller 206, begins incrementing a counter. The counter may be incremented in response to a battery voltage of a battery coupled to the battery bus reaching a threshold voltage indicating that the battery is discharged and should stop discharging power. Act 1102 may include multiple controllers 206 incrementing a respective counter for each other battery which is prepared to provide power. The controllers 206 may use the counter information to determine which battery to draw power from. The process 1100 may then continue to act 1104.

At act 1104, the controllers 206 determine whether the counter has reached a counter threshold. The counter threshold may be any numeric value, for example, 100. The controllers 206 may determine that the battery corresponding to the first counter to reach the counter threshold is the next battery to draw power from. If the controller 206 determines the counter has reached the counter threshold (1104 YES), the process 1100 may continue to act 1106. If the controller 206 determines that the counter has not reached the counter threshold (1104 NO), the process 1100 may return to act 1102 so that the counter can continue to be incremented. In some examples, controllers 206 of batteries with counters that have not reached the counter threshold may determine that another battery has reached the counter threshold by monitoring the voltage on the battery bus. If the voltage on the battery bus rises, then the controllers 206 may determine that a battery reached the counter threshold and then may reset to their initial values.

At act 1106, when the counter threshold is reached or exceeded, the controller 206 may decouple the battery that was previously in use from the battery bus and/or couple to the battery bus the new battery that will provide power to the battery bus. In some examples, the previously coupled battery may be decoupled immediately upon falling to the threshold voltage instead of waiting for the new battery to be fully connected.

With respect to the process 1100, multiple counters can be incremented at once. In some examples, when multiple counters are being incremented simultaneously, each counter may be initialized to a respective value, and those respective values may not be equal to one another. For example, a first counter may be initialized to 80 (out of 100), and the second counter may be initialized to 60. Decoupling the battery occurs when any one of the counters reaches the counter threshold, after which, the counters may be reset until the process 1100 is triggered to begin again, for example, by a battery connected to the battery bus reaching a voltage threshold.

In some examples of the process 1100, the initial value of a counter may be based on the SOC and/or a SOH of the battery associated with the counter. In some examples, the SOH will be used.

In some examples, the acts of process 1100 may be performed, individually or collectively, by the controller 112 and/or a BMS of a battery, or one or more of the controllers 308, 312, 330 of FIG. 3.

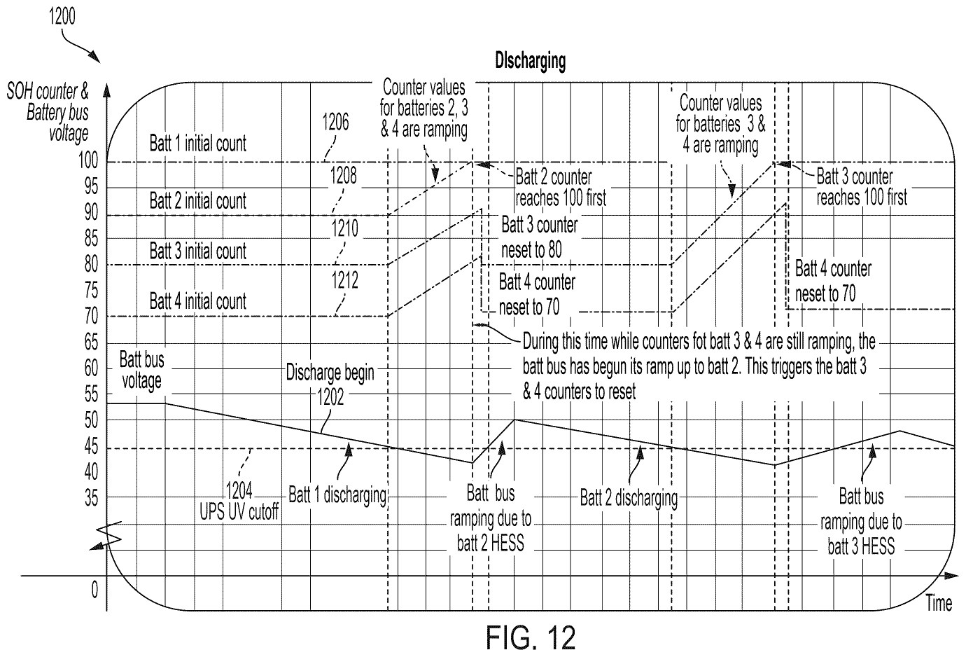

FIG. 12 illustrates a graph 1200 of traces corresponding to a battery bus voltage and various counters, such as those contemplated with respect to process 1100, that further illustrates the use of the counters.

The graph 1200 includes a first trace 1202, a second trace 1204, a third trace 1206, a fourth trace 1208, a fifth trace 1210, and a sixth trace 1212. The first trace 1202 corresponds to a voltage of the battery bus (and therefore to the voltage of a first battery coupled to the battery bus). The second trace 1204 corresponds to a voltage threshold that triggers incrementing of counters and the eventual decoupling of the battery that is coupled to the battery bus and the coupling of a new battery to the battery bus. The third trace 1206 corresponds to a counter threshold (which may be equal to an initial value of a counter associated with the battery connected to the battery bus at time 0). The fourth trace 1208 corresponds to a counter for a second battery, the fifth trace 1210 corresponds to a counter for a third battery, and the sixth trace 1212 corresponds to a counter for a fourth battery.

The graph 1200 also includes a horizontal axis (x-axis) corresponding to time, and a vertical axis (y-axis) corresponding to both unitless counter values between 0 and 100 and the battery bus voltage and voltage threshold.

Initially, the first trace 1202 is constant and then begins decreasing as the corresponding first battery begins to discharge. As the first battery discharges, the first trace 1202 and second trace 1204 eventually intersect. This indicates that the voltage of the first battery coupled to the battery bus has reached the voltage threshold. This triggers the counters associated with the second through fourth batteries to begin incrementing. Thus, the fourth through sixth traces 1208-1212 begin increasing. Eventually, the fourth trace 1208 intersects with the third trace 1206, indicating that the counter of the second battery has reached the counter threshold. At this point, the second battery is coupled to the battery bus and the voltage of the battery bus begins to ramp up as the second battery takes over. Responsive to the counter of the second battery reaching the counter threshold, the first battery that was previously coupled to the battery bus is decoupled from the battery bus.

At a certain point after the fourth trace 1208 intersects with the third trace 1206, the first trace 1202 begins decreasing for the second time. The first trace 1202 decreasing for the second time indicates that the voltage on the battery bus, corresponding at that time to the voltage of the second battery, is decreasing as the second battery discharges. Eventually, the first trace 1202 intersects with the second trace 1204 for a third time, indicating that the voltage of the second battery has fallen below the threshold voltage.

At this point, the counters of the third and fourth batteries begin to increment, corresponding to the fifth trace 1210 and sixth trace 1212 beginning to increase for the second time. When the counter of the third battery reaches the counter threshold, as indicated by the point at which the fifth trace 1210 intersects the third trace 1206, the third battery is coupled to the battery bus and, responsive to the counter of the third battery reaching the counter threshold, the second battery is decoupled from the battery bus. As indicated by the first trace 1202, the battery bus voltage ramps up as the third battery takes over providing power, and eventually the first trace 1202 begins to decrease for a third time, indicating the discharging of the third battery.

The above-described pattern may continue indefinitely. That is, each time a battery voltage reaches the threshold voltage, the counters for the batteries whose voltages remain above the threshold voltage may begin incrementing until one of those counters reaches the counter threshold, at which point the battery whose counter reaches the counter threshold is coupled to the battery bus and the counters are reset to their original values pending the battery bus voltage reaching the threshold voltage again.

The initial counter values for each battery may be based on the priority of that battery. For example, if the counter threshold is 100, as shown in FIG. 12, then the battery with the highest priority may have an initial counter value of 100 (indicating that it is the first battery to be coupled to the battery bus). Each battery with a lower priority may then have a lower initial counter value. For example, the second highest priority battery may have an initial counter value less than the initial counter value of the highest priority battery, and the third highest priority battery may have an initial counter value less than the initial counter value of the second highest priority battery, and the fourth highest priority battery may have an initial counter value less than the initial counter value of the third highest priority battery, and so forth.

Furthermore, the counter process depicted in the graph 1200 also applies to charging the batteries, except that instead of the first trace 1202 starting high and decreasing, the first trace 1202 will start low and increase, instead of the ramp up periods there will be ramp down periods, and the second trace 1204 will start at a higher value and may vary over time depending on the fully-charged voltage of the battery being charged (that is, the second trace 1204 will reflect the fully-charged voltage of the battery being charged).

It is also possible to decrement the counters using a count-down method, in which case the initial values of the counters will be lower for higher priority batteries, and higher for lower priority batteries, and the counters will decrease instead of increase. The threshold counter value may also be changed (e.g., to 0).

As used herein, the term “subgroup” when referring to batteries may include the following meanings: any group of one or more batteries, regardless of battery chemistries; any group of one or more batteries of the same chemistry; and/or all of the batteries.

Examples of the methods and systems discussed herein are not limited in application to the details of construction and the arrangement of components set forth in the description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

Various controllers, such as the controller 112, may execute various operations discussed above. Using data stored in associated memory and/or storage, the controller 112 also executes one or more instructions stored on one or more non-transitory computer-readable media, which the controller 112 may include and/or be coupled to, that may result in manipulated data. In some examples, the controller 112 may include one or more processors or other types of controllers. In one example, the controller 112 is or includes at least one processor. In another example, the controller 112 performs at least a portion of the operations discussed above using an application-specific integrated circuit tailored to perform particular operations in addition to, or in lieu of, a general-purpose processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A power system supporting multiple battery chemistries, comprising:
a battery bus;
a first bidirectional coupler having a first output terminal and a first input terminal, the first output terminal configured to be coupled to the battery bus and the first input terminal configured to be coupled to a first battery having a first battery chemistry;
a second bidirectional coupler having a second output terminal and a second input terminal, the second input terminal configured to be coupled to a second battery having a second battery chemistry, the second battery chemistry being different than the first battery chemistry, and the second output terminal being configured to be coupled to the battery bus; and
at least one controller configured to:
determine a first priority of the first battery and a second priority of the second battery,
responsive to determining the first priority and the second priority, control one of the first bidirectional coupler or the second bidirectional coupler to selectively connect one of the first battery or the second battery to the battery bus based on which priority of the first priority and the second priority is higher.

2. The power system of claim 1 wherein the at least one controller is further configured to:
responsive to an in-use battery coupled to the battery bus falling to or below an undervoltage threshold, selectively decoupling the in-use battery from the battery bus and incrementing a plurality of counters corresponding to other batteries available to be coupled to the battery bus; and
responsive to a first counter of the plurality of counters reaching a counter threshold, selectively coupling, via a respective bidirectional coupler, a battery corresponding to the first counter to the battery bus and resetting each other counter of the plurality of counters to an original value.

3. The power system of claim 1 wherein the at least one controller is further configured to:
determine whether a charging current exceeds a current threshold or falls below the current threshold;
responsive to determining that the charging current exceeds the current threshold, selectively couple one or more batteries to the battery bus; and
responsive to determining that the charging current falls below the current threshold, selectively couple one battery to the battery bus.

4. The power system of claim 1 further comprising a third bidirectional coupler, the third bidirectional coupler including a third output terminal, a third input terminal, a third plurality of switching devices, and a third inductor, wherein the third bidirectional coupler is coupled to the second bidirectional coupler and is configured to be coupled to a third battery having a third battery chemistry.

5. The power system of claim 1 wherein the first bidirectional coupler includes a first plurality of switching devices, and a first inductor, wherein
the first plurality of switching devices includes a first switch, a second switch, a third switch, and a fourth switch, the first switch coupled between a first connection of the first inductor and a positive terminal of the first battery, the second switch coupled between the first connection and a negative terminal of the first battery, the third switch coupled between the negative terminal and a second connection of the first inductor, and the fourth switch coupled between the second connection and the first output terminal.

6. The power system of claim 1 wherein the at least one controller is further configured to determine which of the first priority and second priority is higher by:
determining first battery parameters for the first battery;
determining second battery parameters for the second battery; and
based on the first battery parameters and the second battery parameters, determine the first priority and the second priority, wherein the first battery parameters include one or more of a state of health of the first battery, a remaining life cycle of the first battery, a state of charge of the first battery, or a capacity of the first battery, and wherein the second battery parameters include one or more of a state of health of the second battery, a remaining life cycle of the second battery, a state of charge of the second battery, or a capacity of the second battery.

7. The power system of claim 1 wherein the at least one controller determines which of the first priority or second priority is higher by determining that one battery of the first battery or the second battery has a higher state of health and assigning priority to that one battery.

8. The power system of claim 7 wherein the at least one controller further determines which of the first priority or second priority is higher by determining that each battery has a same state of health and, responsive to determining that each battery has a same state of health, determining that one battery of the first battery or the second battery has a longer remaining life cycle and assigning priority to that one battery.

9. The power system of claim 8 wherein the at least one controller further determines which of the first priority or second priority is higher by determining that each battery has the same remaining life cycle and, responsive to determining that each battery has the same remaining life cycle, determining that one battery of the first battery or the second battery has a higher state of charge and assigning priority to that one battery.

10. The power system of claim 8 wherein the at least one controller further determines which of the first priority or second priority is higher by determining that each battery has a same state of charge and, responsive to determining that each battery has a same state of charge, determining that one battery of the first battery or the second battery has a higher capacity and assigning priority to that one battery.

11. A method of controlling a power system, comprising:
selectively coupling a first battery of a plurality of batteries to a battery bus, the plurality of batteries including batteries having different battery chemistries, the first battery having a first priority and a first chemistry;
monitoring a parameter of the first battery indicative of a remaining charge of the first battery;
determining that the parameter meets a threshold condition indicative of the first battery being discharged below a discharge threshold; and
responsive to the parameter meeting the threshold condition, decoupling the first battery from the battery bus and selectively coupling a second battery of the plurality of batteries to the battery bus, the second battery having a second priority less than the first priority and having a second chemistry different than the first chemistry.

12. The method of claim 11 further comprising:
activating a first buck-boost converter to adjust a voltage of the battery bus to match a first voltage of the first battery responsive to selectively coupling the first battery to the battery bus.

13. The method of claim 12 further comprising:
responsive to the first voltage dropping to an undervoltage threshold, decoupling the first battery from the battery bus and controlling a second buck-boost converter to adjust the voltage of the battery bus to match a second voltage of the second battery as part of selectively coupling the second battery to the battery bus.

14. The method of claim 12 further comprising:
responsive to the first voltage dropping to an undervoltage threshold, decoupling the first battery from the battery bus and controlling the first buck-boost converter to adjust the voltage of the battery bus to match a second voltage of the second battery as part of selectively coupling the second battery to the battery bus.

15. The method of claim 11 wherein, responsive to a charging current from the battery bus being less than a first current threshold, disabling a first buck-boost converter coupled to the first battery and closing a first bypass switch of the first battery to selectively couple the first battery to the battery bus.

16. The method of claim 11 wherein, responsive to a charging current from the battery bus being greater than a first current threshold, activating a first buck-boost converter and selectively coupling, directly or indirectly, the first battery and the second battery to the battery bus.

17. A non-transitory computer-readable medium containing thereon instructions for operating a power system, the instructions instructing at least one processor to:
control at least one first switch to selectively couple a first battery to a battery bus, the first battery having a first battery chemistry and a first priority; and
control at least one second switch to selectively couple a second battery to the battery bus, the second battery having a second battery chemistry different from the first chemistry and a second priority.

18. The non-transitory computer-readable medium of claim 17 wherein the first battery chemistry is a different battery chemistry than the second battery chemistry.

19. The non-transitory computer-readable medium of claim 17, wherein the instructions further instruct the at least one processor to:
initialize one or more counters, the one or more counters including a first counter corresponding to the first battery and a second counter corresponding to the second battery, the first counter initialized to a first value, and the second counter initialized to a second value less than the first value;
increment the first counter at a rate;
increment the second counter at the rate;
responsive to the first counter reaching a threshold value, control the at least one first switch to selectively couple the first battery to the battery bus;
responsive to the first counter reaching the threshold value, reset the second counter;
responsive to the first battery discharging to an undervoltage threshold, increment the second counter at the rate; and
responsive to the second counter reaching the threshold value, control the at least one second switch to selectively coupled the second battery to the battery bus.

20. The non-transitory computer-readable medium of claim 17 wherein the instructions further instruct the at least one processor to:
monitor a first voltage of the first battery;
responsive to the first voltage reaching a first threshold voltage, control the at least one first switch to selectively decouple the first battery from the battery bus;
responsive to decoupling the first battery from the battery bus, selectively couple the second battery to the battery bus;
monitor a second voltage of the second battery; and
responsive to the second voltage reaching a second threshold voltage, control the at least one second switch to selectively decouple the second battery from the battery bus.

21. The non-transitory computer-readable medium of claim 17 wherein the instructions further instruct the at least one processor to:
responsive to a charging current provided at the battery bus being less than a first current threshold, disable a first buck-boost converter coupled to the first battery and close a first bypass switch of the first battery to selectively couple the first battery to the battery bus; and
responsive to the charging current provided at the battery bus being greater than a second current threshold, activating a first buck-boost converter and selectively couple, directly or indirectly, the first battery and the second battery to the battery bus.
